(19) United States
(12) Patent Application Publication
(10) Pub. No.: US 2009/0070425 A1
(43) Pub. Date: Mar. 12, 2009

(54) Data processing system, method of updating a configuration file and computer program product

(75) Inventor: Roland Heumesser, Rottenburg (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/898,444

(22) Filed: Sep. 12, 2007

(51) Int. Cl. G06F 15/16; G06F 17/30

(52) U.S. Cl. 709/205; 707/203; 707/E17.01

(57) ABSTRACT

Provided is a managed node comprising: a management agent comprising:—at least one monitoring element for monitoring at least one of a plurality of managed objects on the managed node according to at least one configuration file, the monitoring element adapted to send a message to a server over a network concerning the, or each managed object;—a discovery element for detecting a discovered state of the managed objects;—a repository for storing a stored state of the managed objects;—a delta detection module for detecting differences between the discovered state and the stored state;—a configuration element for updating at least one configuration file using the detected changes.

### FIELD OF THE INVENTION

The invention relates to agent based operational management systems.

### BACKGROUND

Operational management applies to the maintenance and administration of computer systems and applications running on computer systems. Operational management further applies to networks, in particular to large scale networks such as large scale computer and telecommunications networks. Operational management can be understood as the execution of a set of functions required for controlling, planning, allocating, deploying, coordinating, and monitoring the resources of a network, computer system, or an application. This includes for example, performing functions such as initial network planning, frequency allocation, predetermined traffic routing to support load balancing, cryptographic key distribution authorization, configuration management, forward management, security management, performance management, bandwidth management, and accounting management.

In order to carry out operational management, an operational management system is typically employed. An operational management system comprises operational management software. The operational management software of an operational management system used to monitor for example a network is executed by a computer in the network. An administrator is able to interact with the network management system via a human machine interface provided by the operational management software. Components of the network are represented in the operational management system as objects. The components might be hardware as well as software components. One or more parameters can be associated with each object in the operational management system. The parameters specify how the object is to be monitored by the operational management system. For example, an object might relate to a router in the network. A parameter of this object might then relate to the maximum allowed data rate flowing through the router.

In addition to a network, operational management may be used to monitor any kind of computer resource such as applications, databases, operating systems, disks and CPUs.

The operational management system comprises a central management server and one or more agents. An agent is a software component and can be seen as part of the operational management software. An agent is used to monitor an object in the operational management system. In order to do this, the agent is installed on the component relating to the object, or if the corresponding component is itself a software component, the agent is installed on the hardware component hosting the software component.

An agent monitors the corresponding object according to specifications given to the agent via one or more configuration files. A configuration file is also called a policy file or simply a policy. A configuration file contains information on how the object is to be monitored.

### SUMMARY OF THE INVENTION

According to an embodiment of the present invention there is provided a managed node. The managed node comprises a management agent. The management agent comprises at least one monitoring element for monitoring at least one of a plurality of managed objects on the managed node according to at least one configuration file, the monitoring element is adapted to send a message to a server over a network concerning the, or each managed object. The management agent further comprises a discovery element for detecting a discovered state of the managed objects, and a repository for storing a stored state of the managed objects. The management agent further comprises a delta detection module for detecting changes between the discovered state of the managed objects and a stored state of the managed objects. The management agent further comprises a configuration element for updating the at least one configuration file using the detected changes.

### BRIEF DESCRIPTION OF THE DRAWINGS

In the following, embodiments of the invention will be described, by way of example only, and with reference to the drawings in which:

FIG. 1 is a block diagram of a data processing system,

FIG. 2 is a flow diagram illustrating steps involved in a method for updating a configuration file.

### DETAILED DESCRIPTION

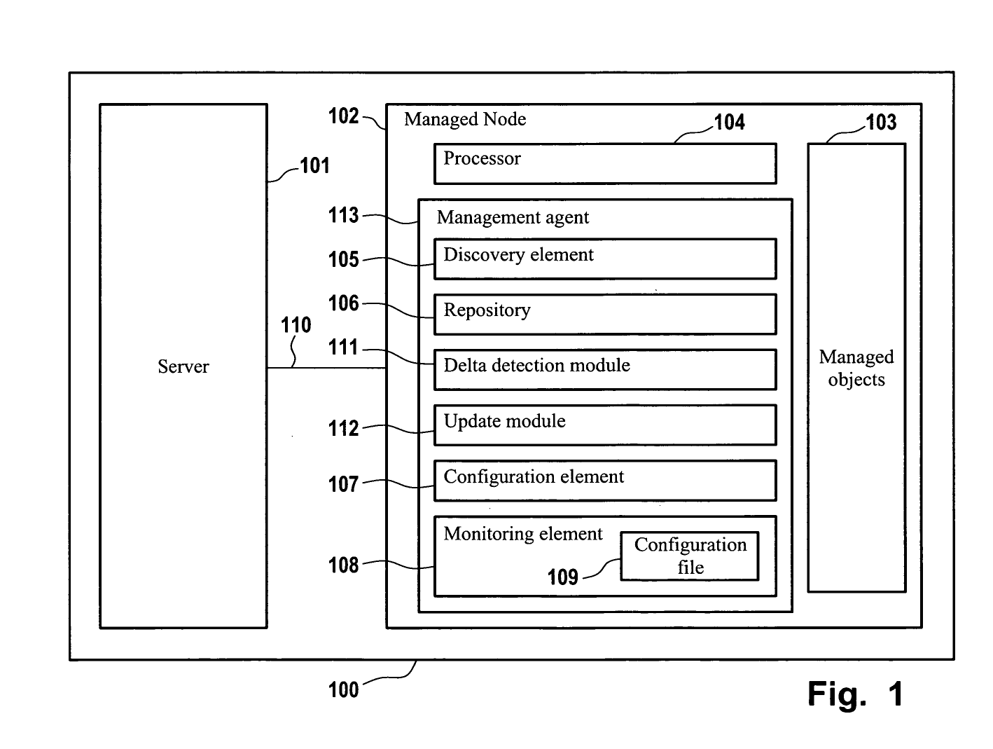

FIG. 1 shows a block diagram of a data processing system 100. The data processing system 100 comprises a server 101, and a managed node 102. Server 101 is an operation management server. Server 101 may be computer system which is part of an operational management system used to monitor managed node 102. The managed node 102 comprises managed objects 103. Managed node 102 may be a network component such as a router. Managed node 102 may be a computer system on which a number of monitored applications are run; the managed objects 103 would then be the monitored application programs. Server 101 is operable to receive messages and alerts which may be displayed to a user or administrator in the when certain events or conditions occur on managed objects 103 on managed node 102. Server 101 and managed node 102 are connected over network 110. Network 110 may be any type of network which allows communication and exchange of data between server 101 and managed node 102. Network 110 may be a wired network such as a local area network, or a wireless network.

Managed node 102 further comprises processor 104. Processor 104 is capable of executing program commands. Managed node 102 also comprises management agent 113 having components discovery element 105, repository 106, configuration element 107, monitoring element 108, delta detection component 111 and update component 112. Discovery element 105 is operable to determine the state of managed objects 103. Repository 106 stores a stored state of managed objects 103. Delta detection module 111 is operable to determine differences between a received state of managed objects 103 and the state of managed objects 103 stored in repository 106. Update component 112 is operable to update repository 106. Configuration element 107 functions to communicate changes in state as deltas to the server 101, and to use deltas received from the delta detection module 111 to update configuration file 109. Monitoring element 108 is operable to monitor the managed objects 103. Configuration file 109 contains instructions for monitoring element 108 to monitor managed objects 103. Configuration file 109 may be executable on monitoring element 108.

Management agent 113 comprises discovery element 105, repository 106, configuration element 107, monitoring element 108, and delta detection module 111 which may have executable components that can be loaded and executed on processor 104. The monitoring element 108 includes configuration file 109. Configuration file 109 comprises detailed technical information on how the managed objects 103 are to be monitored. The monitoring element 108 monitors managed objects 103 according to configuration file 109 and may send alerts to server 101 over network 110 according to conditions specified in configuration file 109. The discovery element 105 discovers the state of the managed objects 103, and sends this discovered state to delta detection module 111. Upon receiving discovered state, delta detection module 111 compares the discovered state of the managed objects with a state stored in repository 106, and determines deltas or differences between the stored state and the discovered state. The term delta being used here to describe data indicative of the differences between the discovered state and the state stored in repository 106. Update component 112 updates repository 106 with the discovered state. Configuration element 107 may receive the deltas from the delta detection module 111, and update the configuration file 109. Additionally, configuration element 107 may send the deltas to the server 101 over network 110. The system thus ensures that monitoring element 108 has an up to date configuration file 109 for monitoring managed objects 103. The term agent is used here to refer to the functionality that operates on the managed node.

The managed node 102 may comprise an monitoring agent 113 comprising a plurality of monitoring elements such as 108 each having configuration files such as 109. In such a case, the configuration element 107 may be operable to update a plurality of configuration files for the plurality of monitoring elements. Each different type of monitoring such as log file monitoring, CPU utilization by a process, and disk utilization may have a separate monitoring element with each monitoring element having separate configuration files maintained by the configuration element.

The plurality of monitoring elements may require configuration files in different formats. The repository 106 may store configuration data in a first format, which is standardized and independent of the specific monitoring elements. The monitoring elements may require configuration files in second and third file formats. The configuration element 107 may then be operable to convert from the first format to the second and third formats for use by the specific monitoring elements.

Server 101 may be operable to send a state for managed objects 103 to management agent 113 on managed node 102. In such an event, delta detection component 111 would determine the differences between the configuration received from server 101 and the state stored in repository 106. Repository 106 is updated by update module 112 and the deltas sent to configuration element 107 configuration element 107 modifies configuration file 109 for use by monitoring element 108 to monitor managed objects 103.

The managed node 102 may for example be a router which is monitored by the management agent 113. The information provided by the configuration file may then instruct the monitoring element 108 to monitor the actual data flow though the router and send an alert message to the server 101 if the actual data flow rate exceeds a certain value, for example a certain number of Megabytes per second. The data flow rate is then one of the parameters comprised within the configuration file 109. In the event that the router is for example taken offline by an administrator, the discovery element 105 would detect the new state and delta detection module 111 would determine a delta from a comparison of the discovered state with the state stored in repository 106. Update module 112 would update repository 106 to the discovered state. The delta would be used to by configuration element 107 to update configuration file 109 which would instruct monitoring element 108 that the router no longer needed to be monitored. Further, the configuration element 107 would send the delta to the server 101 over network 110.

In another example, the managed objects 103 comprise a database, with the managed node 102 being a database system with several storage devices. The management agent 113 may then be used to detect the breakdown of a storage device. The configuration file 109 may then provide information for the monitoring element 108 on how to detect a breakdown in the storage device. The monitoring element 108 may be instructed to monitor the amount of free space on a partition on the storage device. The monitoring element 108 could be instructed by configuration file 109 to send a message over network 110 to server 101 in the event that the free space on the partition was below a certain minimum level. In the system 100, if a new partition was created by an administrator, the new state would be discovered by discovery element 105 and the discovered state would be compared to that stored in repository 106. A delta would be generated indicating the new partition and the delta would be used by the configuration element 107 to update configuration file 109 which would then include instructions for monitoring element 108 to monitor the newly created partition. The configuration element 107 would also send the delta indicating the existence of the newly created partition to server 101. If an administrator were to remove a partition, the new state without the removed partition would be discovered by the discovery element 105 and the state would be sent to delta detection module 111, which would compare the discovered state with the state stored in repository 106. delta detection module 111 would then generate a delta indicating that the partition was no longer in existence and the delta would be sent to configuration element 109. Repository 106 would be updated by update module 112 to no longer include the removed partition and its configuration. Configuration element 107 would, upon receiving the delta from delta detection module 111, amend configuration file 109 and send the delta to server 101 over network 110. The amended configuration file 109 would instruct monitoring element 108 that the removed partition no longer required monitoring.

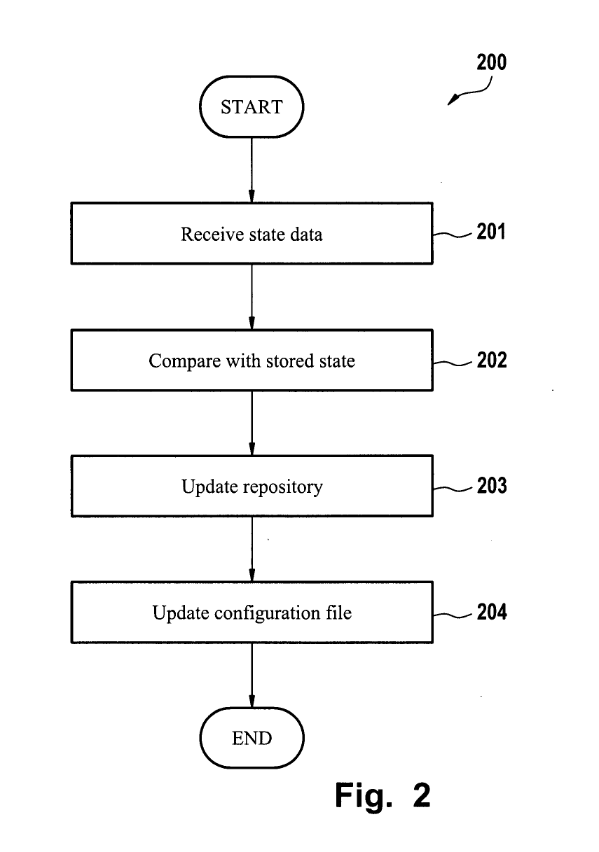

FIG. 2 shows a method 200 for updating a configuration file. The method can be implemented by an agent on a managed node such as 102 in FIG. 1. In step 201 state data is received. State data indicates the state of a managed object or managed objects such as 103 on a managed node 102. The state data may be received from a discovery element such as 105 in FIG. 1 implemented on the managed node 102 which discovers changes to the managed objects 103, or the state data may be received from the server 101 over network 110. In step 202 the received state data is compared with a stored state. State data is stored in repository 106 on managed node 102. As part of the comparison in step 202 deltas or differences between the received state data, and the stored state data are determined. In step 203, the repository is updated with the received state data. In step 204, a configuration file used by a monitoring element such as 108 is updated using the deltas determined in step 202.

The method and system described above have the advantages that local changes to the state of the managed node made on the managed node result in changes to the configuration file and, therefore, changes to the monitoring of the managed node without having to query the server. The method shown in FIG. 2 may include the step of sending the deltas to the server and thus ensuring that the agent configuration contained in the configuration file is always synchronized with the server view of the state of the managed objects. If, for example, a managed resource such as a partition is removed from managed objects 103 by an administrator, the monitoring of managed objects 103 is updated by the discovery element 105 determining the state of the managed objects including that the removed partition is no longer in existence, this state is then sent to the delta detection module which compares the discovered state with the stored state, and determines that the partition has been removed. This delta is then sent to the configuration element which modifies the configuration file of a monitoring element to instruct it that monitoring of the deleted partition is no longer required. Additionally the server 101 is informed of the change. Thus the monitoring of the managed node in an autonomous manner is facilitated.

List of Reference Numerals

| | |
|---|---|
| 100 | Data processing system |
| 101 | Server |
| 102 | Managed node |
| 103 | Managed objects |
| 104 | Processor |
| 105 | Discovery element |
| 106 | Repository |
| 107 | Configuration element |
| 108 | Monitoring element |
| 109 | Configuration file |
| 110 | Network |
| 111 | Delta detection module |
| 112 | Update module |
| 113 | Management agent |
| 200 | Method |
| 201 | Receive state data |
| 202 | Compare with stored state |
| 203 | Update repository |
| 204 | Update configuration file |

1. A managed node comprising:
a management agent comprising:
at least one monitoring element for monitoring at least one of a plurality of managed objects on the managed node according to at least one configuration file, the monitoring element adapted to send a message to a server over a network concerning the, or each managed object;
a discovery element for detecting a discovered state of the managed objects;
a repository for storing a stored state of the managed objects;
a delta detection module for detecting differences between the discovered state and the stored state;
a configuration element for updating at least one configuration file using the detected changes.

2. The managed node of claim 1, the configuration element being operable to send the detected changes to the server.

3. The managed node of claim 1, the management agent further comprising an update module operable to update the stored state as the discovered state.

4. The managed node of claim 1, further operable to receive a state of the managed objects from the server, and the delta detection module being further operable to detect changes between the received state and the stored state.

5. The managed node of claim 1, the repository storing data in a first format, the at least one configuration file being in a second file format and the management agent comprising a further monitoring element, the further monitoring element having a further configuration file in a third format, the configuration agent operable to convert between the first format and the second and third formats.

6. A method of updating at least one configuration file, the at least one configuration file specifying how a plurality of objects on a managed node are to be monitored, the method comprising:
receiving state data of the plurality of objects;
comparing the received state data with a stored state stored in a repository on the managed node and detecting changes;
updating the repository with the received state;
updating the at least one configuration file according to the detected changes.

7. The method of claim 6, wherein the state data is received from a discovery element on the managed node

8. The method of claim 7, further comprising the step of sending the changes detected to the state to a management server.

9. The method of claim 6 wherein the state data is received from a server.

10. The method of claim 6, further comprising the step of monitoring the plurality of objects according to the at least one configuration file.

11. The method of claim 6, the repository having a first format, the configuration file having a second format, and the step of updating the at least one configuration file further comprising converting between the first and the second format.

12. A computer program product comprising instructions which when executed perform a method for updating at least one configuration file, the at least one configuration file specifying how a plurality of objects on a managed node are to be monitored, the method comprising:
receiving state data, representing the configuration of the plurality of objects;
comparing the received state data with state data stored in a repository on the managed node and detecting changes;
updating the repository with the received state data;
updating the at least one configuration file according to the changes detected to the state.

13. The computer program product of claim 12 wherein the state data is received from a discovery element on the managed node.

14. The computer program product of claim 13, the method further comprising the step of sending the changes detected to the state data to a management server.

15. The computer program product of claim 12 wherein the state data is received from a server.

16. The computer program product of claim 12, the method further comprising the step of monitoring the plurality of objects according to the at least one configuration file.

17. The computer program product of claim 12, the repository having a first format, the configuration file having a second format, and the step of updating the at least one configuration file further comprising converting between the first and the second format.
